(19) United States
(12) Patent Application Publication
(10) Pub. No.: US 2023/0345922 A1
(43) Pub. Date: Nov. 2, 2023

(54) Fishing Accessory Securement System and Related Methods

(71) Applicant: William P. Bishop, Midway, UT (US)

(72) Inventors: William P. Bishop, Midway, UT (US); Tyler Steven Howell, Midway, UT (US); Jarrett Brown Sorensen, Midway, UT (US)

(21) Appl. No.: 18/349,819

(22) Filed: Jul. 10, 2023

Related U.S. Application Data
(63) Continuation-in-part of application No. 17/703,756, filed on Mar. 24, 2022.
(60) Provisional application No. 63/203,717, filed on Jul. 29, 2021.

(51) Int. Cl. A01K 77/00; A45F 5/02

(52) U.S. Cl. CPC A01K 77/00; A45F 5/021

(57) ABSTRACT

A net attachment fixture for use in a landing net securement system, the net attachment fixture including a chassis operable to receive a net attachment. The chassis has a front and a rear face and one or more side faces intermediate the front and rear face, the rear face operable to mate against a portion of a landing net. At least one primary strap receiving opening extends through the chassis from the front to the rear face of the chassis and at least one secondary strap receiving opening extends through the one or more sides of the chassis. The strap receiving openings are operable to receive therein one or more straps to secure the net attachment fixture to the landing net.

### PRIORITY CLAIM

This is a continuation-in-part application of U.S. patent application Ser. No. 17/703,756, filed Mar. 24, 2022, which claimed priority of and to U.S. Provisional Patent Application Ser. No. 63/203,717, filed Jul. 29, 2021, each of which is hereby incorporated herein by reference in its entirety.

### BACKGROUND OF THE INVENTION

### Field of the Technology

The present technology relates generally to hand-held landing nets used in fishing. More particularly, the present technology relates to adapting such landing nets so they can be easily carried upon the body of a person fishing (e.g., a “fisher”).

### Related Art

Hand-held landing nets are commonly used in fishing to withdraw a hooked fish from water. Such nets aid a fisher in grasping the landed fish, and also help protect the landed fish during the process. While landing nets are very often carried by those engaged in fly fishing and other fishing endeavors, they are generally only used when landing a fish. As such, most of the time spent fishing does not require the use of the landing net. However, due to the nature of fly fishing in particular, it is desirable to maintain the net near at hand to allow quick use when required.

Thus, while most fishers desire easy access to such nets, they become frustrated by the cumbersome nature of carrying the nets when not in use. Some conventional systems have been developed that allow a user to securely attach the nets to the fisher's body or clothing. However, such systems have generally proved disadvantageous in that they either do not maintain the net in an easily accessible location, or they require significant effort on the fisher's part to disentangle the net from his or her clothing or body.

### SUMMARY OF THE INVENTION

In accordance with one aspect of the technology, a net attachment fixture is provided for use in a landing net securement system. The net attachment fixture can include a chassis operable to receive a net attachment, the chassis having a front and a rear face and one or more side faces intermediate the front and rear face. The rear face can be operable to mate against a portion of a landing net. At least one primary strap receiving opening can extend through the chassis from the front to the rear face of the chassis. At least one secondary strap receiving opening can extend through the one or more sides of the chassis. The strap receiving openings can be operable to receive therein one or more straps to secure the net attachment fixture to the landing net.

In accordance with another aspect of the technology, a net attachment fixture is provided for use in a landing net securement system. The net attachment fixture can include a chassis operable to receive a net attachment, the chassis having a front and a rear face and one or more side faces intermediate the front and rear face. The rear face can be operable to mate against a portion of a landing net. The chassis including three arms, extending outwardly and spaced from one another. At least one primary strap receiving opening can extend through at least one arm of the chassis from the front to the rear face of the chassis. At least one secondary strap receiving opening can extend through at least one arm of the chassis through the one or more sides of the chassis. The strap receiving opening can be operable to receive therein one or more straps to secure the net attachment fixture to the landing net.

In accordance with another aspect of the technology, a landing net securement system is provided, including a landing net including a net body having a net end and a handle end. A net attachment fixture carried by the net body in a location distal from both the net end and the handle end of the net body. The net attachment fixture can include a chassis operable to receive a net attachment, the chassis having a front and a rear face and one or more side faces intermediate the front and rear face, the rear face operable to mate against a portion of the landing net. At least one primary strap receiving opening can extend through the chassis from the front to the rear face of the chassis and at least one secondary strap receiving opening can extend through the one or more sides of the chassis. At least two straps can secure the chassis to the landing net, each strap extending through one of the primary or secondary strap receiving openings.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a plan view of an exemplary landing net having a securement system associated therewith in accordance with an embodiment of the present technology;

FIG. 2 is a front view of the securement system of FIG. 1, shown with the landing net secured to a belt of a fisher;

FIG. 3 is a perspective view of a kit for applying a securement system to a landing net, with a partial view of a landing net for use therewith;

FIG. 4 is a side view of an exemplary clip or clamp for use with the present technology;

FIG. 5 is a perspective view of a net attachment fixture in accordance with another aspect of the technology;

FIG. 6 is a top view of the net attachment fixture of FIG. 5;

FIG. 7 is a side view of the net attachment fixture of FIG. 5;

FIG. 8 is a rear view of the net attachment fixture attached to a landing net;

FIG. 9 is a front view of the assembly of FIG. 8;

FIG. 10 is a front view of the net attachment fixture attached to a landing net in accordance with another aspect of the technology; and

FIG. 11 is a rear view of the assembly of FIG. 10.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### Definitions

As used herein, the singular forms “a” and “the” can include plural referents unless the context clearly dictates otherwise. Thus, for example, reference to “an attachment fixture” can include one or more of such fixtures, if the context dictates.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” an ingredient or element may still actually contain such item so long as there is no measurable effect as a result thereof.

As used herein, the term “about” is used to provide flexibility to a numerical range endpoint by providing that a given value may be “a little above” or “a little below” the endpoint.

Relative directional terms can sometimes be used herein to describe and claim various components of the present invention. Such terms include, without limitation, “upward,” “downward,” “horizontal,” “vertical,” etc. These terms are generally not intended to be limiting, but are used to most clearly describe and claim the various features of the invention. Where such terms must carry some limitation, they are intended to be limited to usage commonly known and understood by those of ordinary skill in the art in the context of this disclosure.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

### Invention

The present technology relates to generally to systems by which a fishing landing net can carried upon the body of a fisher to provide a secure manner of carrying the landing net while also providing easy access to the landing net when desired. The present technology both maintains the net in an easily accessible, yet secure, position on the fisher's body, and allows easy disengagement from the fisher's body.

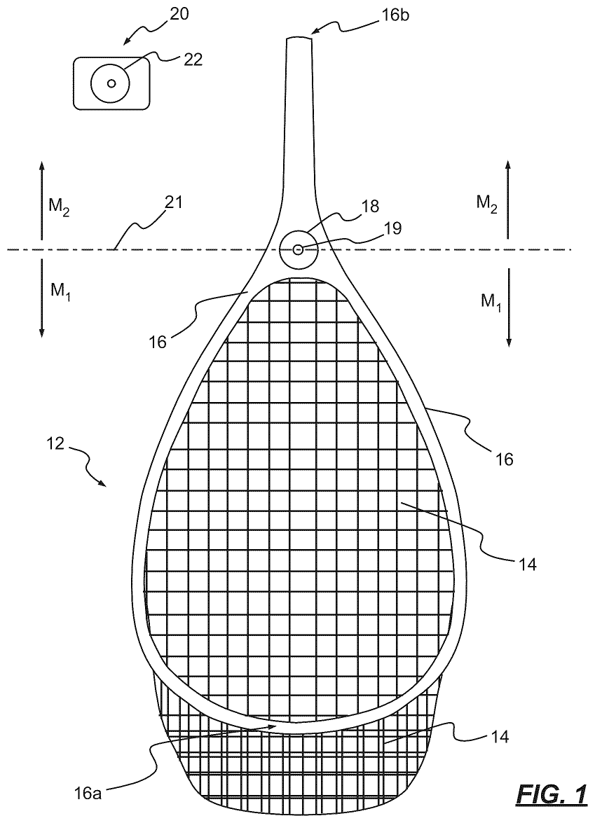

As shown generally in FIG. 1, in one aspect of the technology, a landing net securement system 10 is provided that can include a landing net 12. The landing net can be any of a variety of configurations commercially available. As is known in the art, the net can include a net portion 14 that can include a series of filaments or the like formed of natural fiber thread, nylon, etc. The net can include a net body 16 having a net end 16a and a handle end 16b. The net body can be formed from a variety of known materials, including wood, aluminum, polymers, etc.

A net attachment fixture 18 can be carried by the net body 16 in a location distal from both the net end 16a and the handle end 16b of the net body. While this attachment position can vary, in the examples shown the attachment fixture 18 is carried by the net body near the yoke, immediately prior to the location where the net body expands into a hoop to which the net portion 14 is generally attached. The system can also include a body assembly, shown by example as a clip assembly 20 (see also FIG. 4), attachable to clothing worn by a fisher. The body or clip assembly can carry a body attachment fixture 22 that can be operable to mate with the net attachment fixture 18 to enable securement of the landing net to the clothing of the fisher. While the body assembly can include a clipping structure, it is to be understood that the body assembly can be attached to or associated with clothing in a variety of manners: for example, it can be sewn to clothing, attached with hook-and-loop fasteners, etc.

As that term is used herein, “clothing” can refer to a variety of garments or structures typically worn or carried on a user's body. Examples include, without limitation, belts, straps, vests, pants, shirts, coats, carrying packs, suspenders, and the like.

FIG. 2 illustrates the technology in use retaining or securing the net 12 to a belt or strap 24 carried upon the person (in this case, about the hips) of a fisher 26. As can be seen, attachment fixture 18 carried by the net is attached to attachment fixture 22 carried by the clip 20. The clip 20 is in turn secured to the belt or strap 24. In this manner, the fisher can perform all of the usual tasks associated with fishing, without the net interfering in any significant manner with normal activity. However, when needed, the net is close at hand and can be easily and quickly deployed by the fisher for use. When finished with the net, the fisher can very easily reengage the attachment fixtures 18, 22 and again secure the net in position on his or her body.

The attachment fixtures 18, 22 can take a variety of forms, so long as the two can engage one another with sufficient force to function in the manner described herein. In one embodiment, the attachment fixtures comprise or include a material that creates a magnetic force between the two fixtures. For example, one or both of the fixtures can comprise or include a ferromagnetic material, such as iron, cobalt, nickel, etc., and one or both of the fixtures can be magnetized. In some embodiments, both of the fixtures comprise or include a magnet. As will be appreciated from the figures, once the fixtures are placed in near vicinity to one another, they form an attachment that maintains the net in the desired position. In other embodiments, other attachment fixtures can be utilized, such as hook-and-loop fasteners, mechanical “holster” arrangements, friction-fit arrangements, etc.

The present technology advantageously provides manners by which the handle end 16b of the net 14 can be positioned upwardly relative to a fisher's hip, to enable the fisher to very easily grasp the handle. The position shown in FIG. 2 is advantageous not only for this feature, but this position allows the user to utilize leverage to disengage the attachment fixtures 18, 22 from one another. Once the user grasps the handle portion of the net, he or she can apply force outwardly at shown at 30. This force translates to an inward force 32 applied to the user's leg. This leverage amplifies the force applied by the user to the handle through the attachment fixtures. In this manner, the force applied by the user to separate the attachment fixtures is greater than he or she could normally apply by hand.

Accordingly, in one aspect of the technology, the handle end 16b of the net 14 is remains untethered and free to move when the net is in the storage position (that shown in FIG. 2), to enable movement of the handle end away from the user's 26 body to enable the user to apply the leveraged force. In another aspect, both the handle end 16b and the net end 16a are untethered and free to move when the net is in the storage position. The user can grasp the handle end (e.g., grip portion 17) from above, without any attachment structure interfering with the grasp. In one aspect, the attachment fixtures are disengageable by applying a force outward from the user's body or waist, so that the fisher need not lift the net upwardly or downwardly when disengaging it from his or her body.

This results in the ability to utilize much stronger attachment fixtures than might otherwise be feasible. It has been found, for example, that when a relatively weak magnet combination is used for the attachment fixtures, the net may become inadvertently dislodged during activities normally encountered during fishing. For example, the net may become dislodged as the fisher moves past brush or foliage. On the other hand, if a conventional attachment approach is utilized with a very strong magnet combination, the net may not easily separate from the user, but some users may have difficulty separating the magnets when it is desired to use the net.

Even large ferrite magnets, which are not as strong as other permanent magnets, can be difficult for some users to separate by hand. Magnets such as neodymium magnets can be very difficult for users to separate by hand. The present arrangement, however, can provide sufficient leverage to allow even small users to separate the attachment fixtures 18, 22, by applying a leveraging force 30 to the handle end 16b of the net 12, which then applies a force 32 against the user's leg, resulting in a sufficient force 34 to separate the attachment fixtures. In this manner, a strong enough attachment force can be applied to maintain the net in position on the user, while still allowing users to remove the net when desired.

As illustrated in FIG. 1, in one embodiment of the technology, the net attachment fixture 18 can be carried by the net body 16 in a location such that a mass “M₁” of the net body between the net attachment fixture 18 and the net end 16b is greater than a mass “M₂” of the net body between the net attachment fixture 18 and the handle end 16a. In the example shown, line 21 represents the location of attachment of the net, with one mass existing below and one mass existing above this delineation. This embodiment can aid in maintaining the handle end of the net in a desired location to enable a user to easily grasp the handle. As the net end will tend to rotate downwardly relative to the handle end about the attachment point, this feature allows the system to substantially self-correct for orientation without the user having to invest significant attention when returning the net to the secured position.

Further to this, the manner in which the net attachment fixture 18 and the body attachment fixture 22 can be varied to provide relative rotatability at the connection point. For example, one or both the net attachment fixture or body attachment fixture can be rotatably attached to its respective component. This can be accomplished in a number of manners. In one embodiment, for example, the net attachment fixture can comprise or include a hole formed through a center thereof, and a fastener (19 in FIG. 1, e.g., a bolt and nut, screw, etc.) can be installed through the hole and into the body 16 of the net 14. In this manner, the net attachment fixture 18 can rotate relative to the net body.

This same approach can be utilized with the body attachment fixture on the clip 20, in addition to or instead of the net body attachment rotation. In other embodiments, the attachment fixtures can be rotatably fixed relative to their respective component, but the magnets (or ferromagnetic material) utilized can self-align as they attach to one another. This can be accomplished, for example, using a magnetization technique that provides directionality to the magnetic attraction between the attachment fixtures.

Using one or both of these approaches can result in the net being rotatable relative to the user when the net is in the storage position shown in FIG. 2. In this manner, the user can position the net in the easiest position for him or her to manipulate when storing or retrieving the net. The net can be rotatable when the attachment fixtures 18, 22 are coupled one to another. This rotatability can be provided with one or both attachments rotating relative to their respective bodies, or with each being fixed to their respective bodies and the coupling between them providing rotatability.

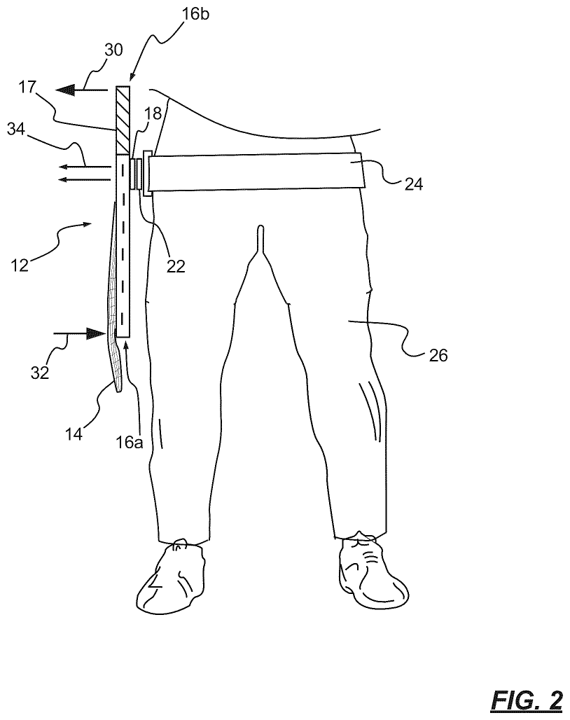

As illustrated in FIG. 3, the system can also include a tether 36 that can be coupled between the landing net 14 and the clip assembly 20. The tether can be formed from an elastic material, to enable a user to extend the net from the clip assembly when desired. The elasticity in the tether, however, aids the user in returning the net to the clip assembly after use, and also aids in retrieving the net should it be inadvertently dropped.

FIG. 2 also illustrates components of a kit provided by the present technology. The kit can include a net attachment fixture 18 and a clip assembly 20, attachable to clothing worn by a fisher. The clip assembly can carry a body attachment fixture 22. Instructions 38 can be provided for attaching the net attachment fixture to the net body in a location distal from both the net end and the handle end of the net body. The net attachment fixture thereby becomes operable to mate with the body attachment fixture to enable securement of the landing net to the clothing of the fisher. In accordance with one aspect of the technology, the instructions can instruct attachment of the net attachment fixture on a location of the body of the net such that a mass of the net body between the net attachment fixture and the net end is greater than a mass of the net body between the net attachment fixture and the handle end.

FIG. 4 illustrates schematically operation of one exemplary clip assembly 20. In this example, the clip assembly can include a pair of pivotally attached clamshells 20a, 20b, and a latch 20c. In use, a fisher can open the clamshells and install the clip about a belt, pants, suspenders, shirt, etc., of the fisher. The clip assembly can carry the body attachment fixture 22. It is noted that, while the body attachment fixture 22 is illustrated as attached to or carried by the clip assembly, in some embodiments the body attachment fixture can be attached directly to an article of clothing of the fisher, or to some other accessory the fisher may carry. In particular, a belt can be relatively easily modified to carry the body attachment fixture, in which case the clip assembly may not be necessary.

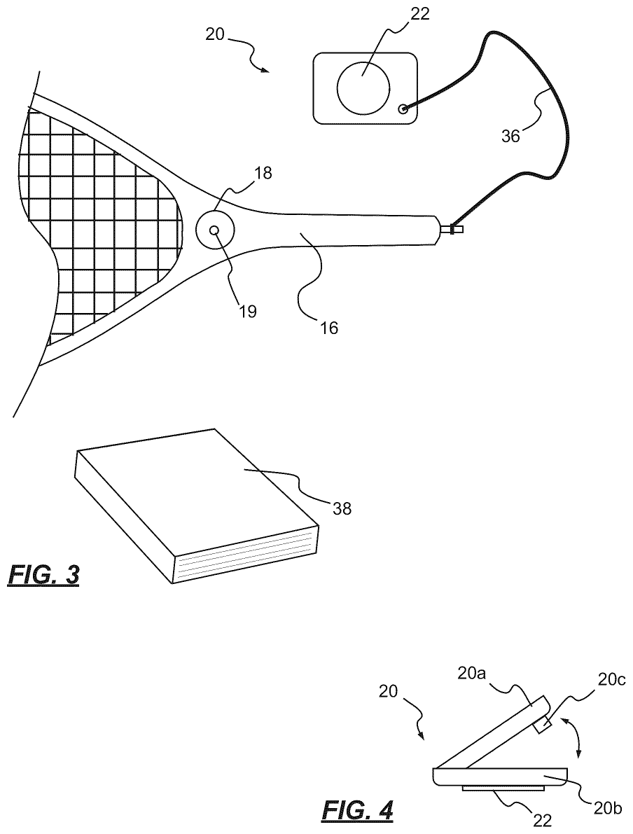

FIGS. 5-11 illustrate further embodiments of the technology. In these embodiments, a net attachment fixture 18a is provided for use in a landing net securement system. In these examples, the net attachment fixture can include a body or chassis 40 that can be operable to receive a net attachment (e.g., a magnet, a component of a hook-and-system, a mechanical latch, or the like 25 shown in FIG. 10). The net attachment 25 can be operable to mate with a corresponding component on the body attachment fixture 22 (e.g., a corresponding magnet or ferromagnetic material, hook-and-look component, mechanical latch or receiver, etc.). The chassis can include a front 42 and a rear 44 face and one or more side faces 46 intermediate the front and rear face (see FIG. 7, for example). The rear face 44 can be operable to mate against a portion of the landing net 16, as shown for example in FIGS. 8 through 11.

At least one primary strap receiving opening 48a, 48b, 48c, etc., can extend through the chassis 40 from the front 42 to the rear face 44 thereof. At least one secondary strap receiving opening 50a, 50a′, 50b, etc., can extend through the one or more sides 46 of the chassis. The various strap receiving openings can be operable to receive therein one or more straps 52a, 52b, 52c, etc., (FIGS. 8-11) to secure the net attachment fixture to the landing net.

This aspect of the technology can advantageously allow securement of the net attachment fixture 18a to the net body 16 without requiring the application of adhesive to the net body, and without damaging or altering the net body. For example, rather than drilling the net body to receive a screw or other fastener, this aspect of the technology allows the attachment fixture to be secured against the net body without in any way damaging, marring or affecting the net body. This process can also be easily reversed—allowing an operator to remove the net attachment system and restoring the landing net to its original condition quickly and safely.

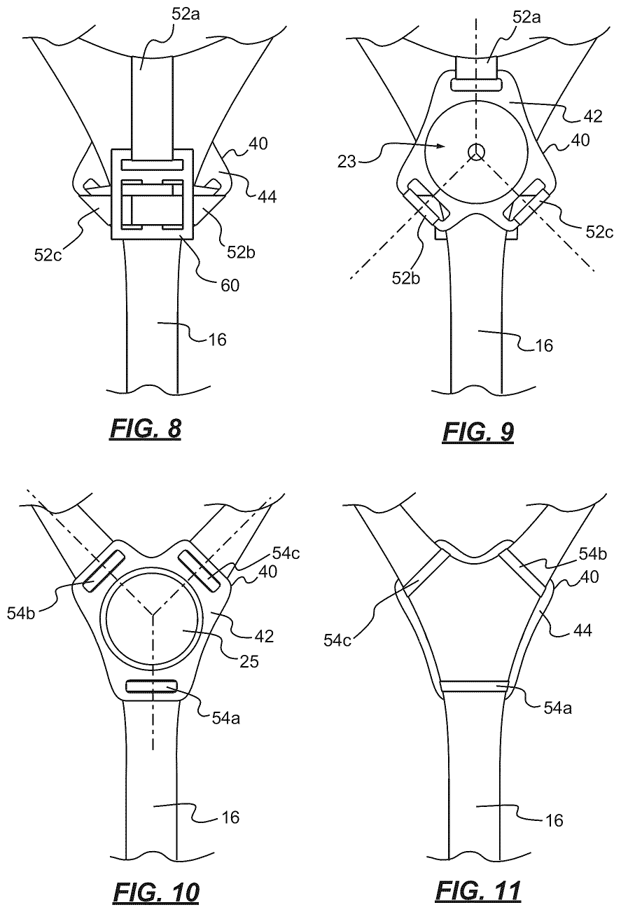

The arrangement of the various strap receiving openings allows an operator to select which type of strap is optimal for any particular landing net configuration. In the example shown in FIGS. 8 and 9, the primary strap receiving openings 48a, 48b, 48c, etc., are used to allow straps 52a, 52b, 52c to be inserted from the front face 42 through the rear face 44. In the example shown in FIGS. 10 and 11, the secondary strap receiving openings 50a, 50a′, 50b, etc., are used to allow straps 54a, 54b, 54c, etc., to be inserted through the side face 46.

The net attachment fixture 18a receives the various straps in a multitude of directions, allowing the operator to select and configure the straps in whichever manner is best for the landing net in question. For example, some wooden landing nets include a relatively wide and high throat area. The configuration shown in FIGS. 8 and 9 may work best for this type of net, as two sets of the primary strap receiving openings 48b, 48c can be oriented downwardly, one on each side of the handle of the landing net, to receive therein straps 52b and 52c. The remaining primary strap receiving opening can be oriented upwardly, such that strap 52a centers the attachment relative to the landing net.

In the configuration shown in FIGS. 10 and 11, two sets of the secondary strap receiving openings 50b, 50b′, 50c, 50c′, etc., (not visible in this view) are oriented upwardly, each set roughly aligned with one of the two arms of the loop of the landing net that diverge upwardly from the throat. Straps 54b and 54c can be installed through each of one of these sets of openings. A single set of secondary strap receiving openings 50a, 50a′ (not visible in this view) can be oriented downwardly, aligned with the handle of the landing net, to receive therein strap 54a. This configuration has proven to work well with metal landing nets, as they tend to have smaller throat areas.

The primary strap receiving openings 48 can be configured to receive well a wider, ribbon-like material such as a nylon strap. The secondary strap receiving openings 50 can be configured to receive well thinner materials, such as the products commonly known as cable ties. As will be appreciated from the figures, in one example, each primary strap receiving opening can intersect with, or overlap, a secondary strap receiving opening. Put another way, a strap that is fed through a primary strap receiving opening can, in some embodiments, consume the space created adjacent a secondary strap receiving openings (or between a pair of the secondary strap receiving openings).

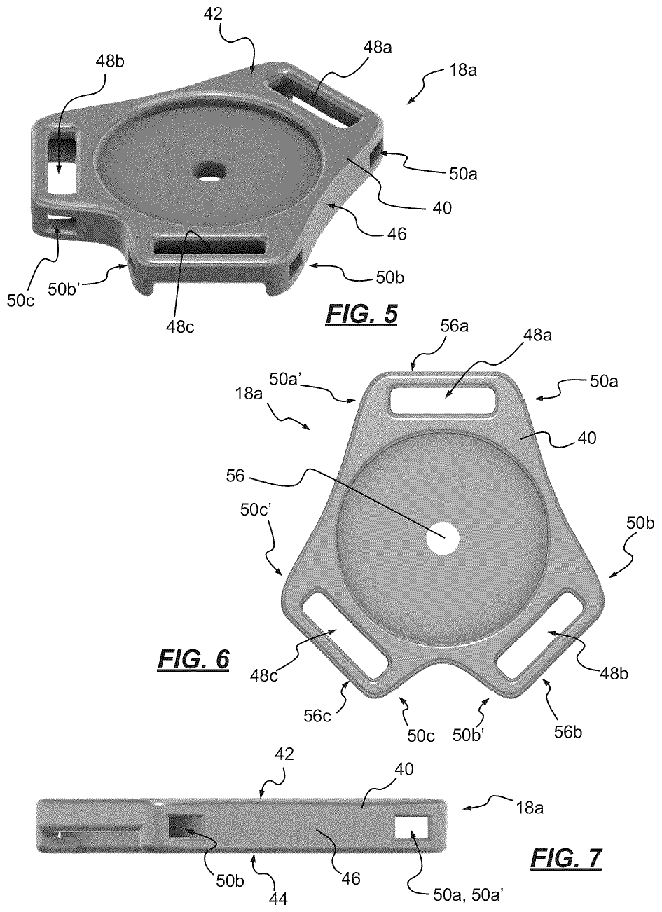

FIG. 8 illustrates an exemplary buckle 60 that can be used in combination with the straps 52a, 52b, 52c. This buckle can gather all of the straps and allow an operator to securely cinch them to tightly retain the chassis 40 against the landing net. Note that while three straps 52a, 52b, 52c are identified in the figures, these straps may, in fact, be a single strap, or two straps that converge at the buckle. Operation of straps 54a, 54b, 54c, etc., can be similar to that used with conventional cable ties. These types of straps can include a cinch end and an extension end; once positioned about the net body, the extension end can be securely cinched, or “zipped” into the cinch mechanism. The chassis 40 can include one or more arms 56a, 56b, 56c, etc., (FIG. 6) that extend outwardly from a body proper of the chassis. The primary and secondary strap receiving openings can be formed through these arms. As will be appreciated from FIGS. 9 and 10, the arms can be aligned such that two of the arms form an angle of about 90-degrees with one another, while each forming an angle of about 135-degrees relative to a third arm. In this manner, a Y-shaped arrangement is achieved, allowing, in one embodiment, one arm to be aligned with the handle of the landing net, and the other two arms to be aligned with the arms of the loop that diverge from the throat area of the landing net.

Each arm 56 can include both one or more primary strap receiving openings 48 and one or more secondary strap receiving openings 50. This arrangement of the varying strap receiving openings can allow one type of strap to be used, for example, in the primary set of openings in one arm, yet at the same time another type of strap can be used in the secondary set of openings in another arm. This allows further flexibility in attaching the chassis to a variety of landing net configurations.

As shown in FIGS. 9 and 10, the chassis 40 can include a recess 23 for receiving therein a net attachment (e.g., magnet, hook-and-loop fastener, or other suitable attachment) 25. In one aspect, the recess and the net attachment can include a common outer shape such that the net attachment nests within the recess, with lateral movement of the net attachment being thereby restricted by the walls of the recess. The net attachment can be bonded or mechanically fastened within the recess, to avoid having to attach the magnet or similar structure to the landing net itself. Opening 56, shown in FIG. 6, can be used for this purpose. Advantageously, this arrangement can avoid having to bond or screw the attachment (e.g., magnet) directly to the landing net, which may otherwise mar or scratch or damage the landing net.

In accordance with another aspect of the technology, a method can be provided of providing a securement system to a landing net having a net body with a net end and a handle end. The method can include attaching a net attachment fixture to the net body in a location distal from both the net end and the handle end of the net body. The landing net can be associated with a clip assembly, the clip assembly being attachable to clothing worn by a fisher, the clip assembly carrying a body attachment fixture operable to mate with the net attachment fixture to thereby enable securement of the landing net to the clothing of the fisher.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the examples.

I claim:

1. A net attachment fixture for use in a landing net securement system, the net attachment fixture comprising:
a chassis operable to receive a net attachment, the chassis having a front and a rear face and one or more side faces intermediate the front and rear face, the rear face operable to mate against a portion of a landing net;
at least one primary strap receiving opening extending through the chassis from the front to the rear face of the chassis; and
at least one secondary strap receiving opening extending through the one or more sides of the chassis;
the strap receiving openings operable to receive therein one or more straps to secure the net attachment fixture to the landing net.

2. The fixture of claim 1, wherein the chassis further comprises a recess for receiving the net attachment therein.

3. The fixture of claim 2, wherein the recess and the net attachment include a common outer shape such that the net attachment nests within the recess with lateral movement of the net attachment being thereby restricted.

4. The fixture of claim 1, further comprising a pair of primary strap receiving openings, spaced from one another about a perimeter of the chassis.

5. The fixture of claim 4, further comprising a third primary strap receiving opening, spaced from each of the pair of primary strap receiving openings about the perimeter of the chassis.

6. The fixture of claim 1, further comprising a pair of secondary strap receiving openings, spaced from one another about a perimeter of the chassis.

7. The fixture of claim 6, further comprising a third secondary strap receiving opening, spaced from each of the pair of secondary strap receiving openings about the perimeter of the chassis.

8. The fixture of claim 1, wherein the fixture includes three primary strap receiving openings spaced from one another about a perimeter of the chassis, and three secondary strap receiving openings spaced from one another about a perimeter of the chassis.

9. The fixture of claim 1, wherein the at least one primary strap receiving opening and the at least one secondary strap receiving opening intersect one another.

10. A net attachment fixture for use in a landing net securement system, the net attachment fixture comprising:
a chassis operable to receive a net attachment, the chassis having a front and a rear face and one or more side faces intermediate the front and rear face, the rear face operable to mate against a portion of a landing net;
the chassis including three arms, extending outwardly and spaced from one another;
at least one primary strap receiving opening extending through at least one arm of the chassis from the front to the rear face of the chassis; and
at least one secondary strap receiving opening extending through at least one arm of the chassis through the one or more sides of the chassis;
the strap receiving openings operable to receive therein one or more straps to secure the net attachment fixture to the landing net.

11. The fixture of claim 10, the chassis further comprising a recess for receiving the net attachment.

12. The fixture of claim 11, wherein the recess and the net attachment include a common outer shape such that the net attachment nests within the recess with lateral movement of the net attachment being thereby restricted.

13. The fixture of claim 10, further comprising a primary strap receiving opening extending through each arm.

14. The fixture of claim 10, further comprising a secondary strap receiving opening extending through each arm.

15. The fixture of claim 14, wherein the primary strap receiving opening intersects the secondary strap receiving opening.

16. A landing net securement system, comprising:
a landing net including a net body having a net end and a handle end;
a net attachment fixture carried by the net body in a location distal from both the net end and the handle end of the net body;
the net attachment fixture including:
a chassis operable to receive a net attachment, the chassis having a front and a rear face and one or more side faces intermediate the front and rear face, the rear face operable to mate against a portion of the landing net;
at least one primary strap receiving opening extending through the chassis from the front to the rear face of the chassis; and
at least one secondary strap receiving opening extending through the one or more sides of the chassis; and
at least two straps securing the chassis to the landing net, each strap extending through one of the primary or secondary strap receiving openings.

17. The system of claim 16, wherein the chassis further comprises a recess for receiving the net attachment, the recess and the net attachment including a common outer shape such that the net attachment nests within the recess with lateral movement of the net attachment being thereby restricted.

18. The system of claim 16, further comprising three arms, extending outwardly from the chassis and spaced from one another.

19. The system of claim 18, further comprising a primary strap receiving opening extending through each arm.

20. The system of claim 19, further comprising a secondary strap receiving opening extending through each arm, the secondary strap receiving opening intersecting the primary strap receiving opening.
